(19) United States
(12) Patent Application Publication
(10) Pub. No.: US 2006/0191573 A1
(43) Pub. Date: Aug. 31, 2006

(54) Sanitizable float valve

(76) Inventor: Mauri Salmisuo, Tuusula (FI)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/552,884

(22) PCT Filed: May 10, 2004
(86) PCT No.: PCT/FI04/00277

§ 371 Date: Oct. 13, 2005

(30) Foreign Application Priority Data
May 16, 2003 (FI) 20030737

(51) Int. Cl. F16K 31/18

(52) U.S. Cl. 137/442

(57) ABSTRACT

A sanitizable float valve body, a closing element located into the body and a float connected to a lever arm for controlling the closing element, said closing element being set into the valve chamber so that the allowance between the chamber and the closing element allows a part of the liquid to discharge through this allowance, when the valve is open.

The present invention concerns a float valve, the tolerances of a slide of said valve allowing liquid to discharge between the valve chamber and the slide in order to flush the surfaces thereof.

There are numerous different float valves known in the art. Their most essential field of application are mechanical level indicators. The operation of a float valve is regulated by a float, as indicated by its name. The float is in general a swimmer located outside the valve and usually connected to the valve by means of a lever arm. The float swims in the liquid tank on the liquid surface, whereby the amount of the liquid controls the operation of the float valve in a desired way opening and closing the valve when necessary.

According to the present invention, a sanitizable version of a float valve is provided in order to keep the valve and its surfaces clean. This is especially important in an environment, where the purity of the liquid flowing through the valve is essential.

In a valve in accordance with the present invention, the sanitizability of the float valve is provided by locating the opening and closing element of the valve into the valve chamber so, that an allowance is left between the valve chamber and the closing element, allowing a part of the liquid that flows through the valve to discharge through the allowance between the closing element and the valve chamber when the valve is open, thus flushing these surfaces. An example of this kind of a valve is for example a valve regulating the intake of the filling water of a cleansing circulation to be used for disinfection. The valve is thereby controlled by the water amount of the circulation, which is effected by the impurities to be removed and the clean water to be taken into use. The water flushing the valve flows to the water tank of the circulation, in other words, to the same place as the water that flows through the valve when the valve is open. In addition, the valve can in this kind of a use be sterilized, when necessary, with hot water and/or steam.

By means of a valve operation described above, the agglomeration of impurities can be prevented onto surfaces between the valve chamber and the- closing element, from where these impurities would move into the liquid circulating through the valve. In addition, the functionality of the valve can be improved by preventing the closing element from sticking into the valve chamber due to impurities.

More precisely, the float valve of the present invention is characterised in by what has been stated in the characterising part of claim 1.

In the following, the present invention will be described in more detail, with reference to the enclosed drawing, wherein

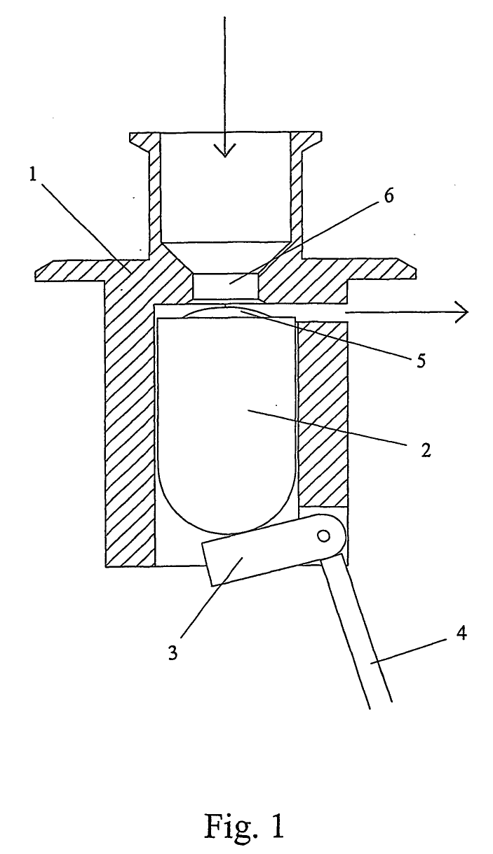

FIG. 1 shows schematically a float valve in accordance with the present invention as a partial cross section.

Essential parts of the float valve in accordance with the invention as shown in FIG. 1 comprise a valve body (1), shown as a vertical cross section, a slide (2), a guide cam (3), lever arm (4) and floater (not shown), attached to the lever arm. In the figure, the valve is illustrated in its open-position and the arrows in the figure show the main path of the liquid flowing through the valve. The arrow pointing at the valve illustrates the liquid entering the valve and the arrow pointing away from it illustrates the liquid leaving the valve.

When the valve is open, in the position shown by the figure, the liquid flows from one end of the valve body (1) into the valve (entering-arrow), and it flows away through the opening on the side of the valve (leaving-arrow). Additionally, a part of the liquid flowing trough the valve continues through the valve in the direction shown by the entering arrow, through the gap between the walls of the valve chamber and the slide (2) and leaves the valve through the opposite end of the valve. Thus, the liquid leaving through the valve chamber flushes the walls of the valve chamber and the slide and prevents agglomeration of impurities to the valve.

The operation of the valve is regulated by a float attached to a lever arm (4) according to the liquid level. A guide cam (3) is regulated by the float through the lever arm, and the guide cam for its part moves the slide (2) of the valve. The front surface of the slide is equipped with a curved projective portion (5), said projective portion pressing against the inlet (6) of the liquid on the front wall of the valve chamber, when the valve is closed. Correspondingly, the edge of the inlet (6) of the liquid on the front wall of the valve chamber is chamfered. Thereby a tight connection between the front surface and the front wall of the valve chamber is provided, when the valve is closed, despite the allowance between the slide and the valve chamber.

The form of the combination of the valve float and the lever arm is determined by the position of the valve with respect to the liquid level controlling its operation. Thus, the valve in accordance with the present invention is not dependent on any definite combination of the float and the lever arm, or to its form.

The form of the closing element of the valve in accordance with the present invention is preferably designed so, that the length of the closing element is substantially bigger than the diameter of the closing element. This is to ensure the correct operation of the closing element and to prevent eventual wedging of the closing element due to the allowance or other corresponding disturbance of the closing operation due to the allowance. Additionally, the tight closing of the valve can thereby be guaranteed, because the eventual lateral movement of the closing element can be adequately compensated by the curved projective portion of the front surface of the closing element, said projective portion also positioning the closing element of the valve to the correct place when the valve is being closed.

The valve in accordance with the present invention is, however, not limited to a definite form of the slide. Other optional functional forms of the slide are, among others, flap and ball.

By means of the lever arm and the guide cam of the float of the valve an adequate surface force for closing the valve can be determined, by which an adequate sealing of the slide against the liquid inlet in the front wall of the chamber can be reached.

In addition, in the valve solution in accordance with the present invention, there are no limitations for the direction of the liquid outlet in the radial direction of the valve cross section, but it can be chosen as desired.

In one preferable embodiment of the invention the float valve comprises a valve housing having a substantially cylindrical chamber, said chamber having in its one end a water inlet; slide element having a substantially circular cross section, movable in the chamber in its longitudinal direction and having in its end facing towards the inlet of the valve a partly convex closing surface and said slide element having a rounded other end; on the side of the chamber, in the end facing towards the inlet, a discharge; a guide cam effecting the rounded end of the slide and being attached hinged to the body of the valve; a lever arm attached to the guide cam; and a float attached to the lever arm.

The float valve in accordance with the invention or the components thereof are not limited to any specific material, but it has been stated that a slide made of or plated with fluor-bearing polymer like PTFE is especially suitable in the solution in accordance with the invention.

The valve can preferably be equipped with a flange, so that it is be easily mountable to the inlet pipe for liquid and attached to its place with a bayonet flange joint. Bayonet flange joint in this connection refers to connecting the valve and the pipe by means of a flange mounted into each of them so, that the flanges are attached to each other with a bayonet coupling, like a clamping collar around the outer edge of the flanges, said collar connecting the flanges with each other.

1. A sanitizable float valve to be used in water purification circulation, said valve comprising a body (1), a closing element (2) placed into the body, the length of said closing element being essentially bigger than the diameter of the closing element, and a float connected to a lever arm (4) for controlling the closing element, characterized in that the allowance between the chamber of the body and the closing element allows a part of the liquid flow to discharge through this allowance thus flushing said surfaces when the valve is open.

2. A float valve in accordance with claim 1, characterized in that the closing element (2) of the valve is equipped with a partly convex sealing surface (5) adapting itself to the liquid inlet (6) of the valve.

3. A float valve in accordance with claim 1, characterized in, that the end of the closing element (2) opposite to the front surface is rounded.

4. A float valve in accordance with claim 1, characterized in, that the valve chamber has a substantially cylindrical form and the closing element (2) of the valve adapting itself thereto has a substantially circular cross section.

5. A float valve in accordance with claim 1, characterized in, that the material of the closing element (2) is PTFE.

6. A float valve in accordance with claim 1, characterized in, that the valve is equipped with elements for attaching the valve to a liquid inlet pipe by means of a bayonet flange coupling.
